(19) United States
(12) Patent Application Publication
(10) Pub. No.: US 2020/0021497 A1
(43) Pub. Date: Jan. 16, 2020

(54) TRAFFIC SIMULATOR FOR DATA TRANSMISSION SYSTEM

(71) Applicant: ARRIS Enterprises LLC, Suwanee, GA (US)

(72) Inventors: Tushar Mathur, Mississauga (CA); Benjamin Widrevitz, Downers Grove, IL (US); Thomas J. Cloonan, Lisle, IL (US)

(21) Appl. No.: 16/509,486

(22) Filed: Jul. 11, 2019

Related U.S. Application Data
(60) Provisional application No. 62/697,594, filed on Jul. 13, 2018.

(51) Int. Cl. H04L 12/24; H04H 20/78; H04L 12/26

(52) U.S. Cl. CPC H04L 41/145; H04L 41/5038; H04L 43/50; H04L 43/0817; H04H 20/78

(57) ABSTRACT

Systems and methods that realistically simulate traffic in a communications network.

### CROSS REFERENCE TO RELATED APPLICATIONS

This application claims the benefit of priority to U.S. Provisional Application No. 62/697,594 filed on Jul. 13, 2018.

### BACKGROUND

The subject matter of this application generally relates to devices and methods used to simulate real-world network traffic within communication systems.

Traffic engineering is an important endeavour that attempts to provide sufficient network resources (e.g. link bandwidth capacity, processing power, etc.) to maintain a desired Quality of Experience level for a single subscriber or for a combined set of subscribers who share interconnection links in the Internet or who share processing resources in a Server. For example, traffic engineering is useful to model, forecast, and/or test the number of telephone trunks required for telephone subscribers sharing a telephone link, or the number of touch-tone receivers that are needed in a central office to support a given set of telephone subscribers. Traffic engineering can also be used to determine the amount of LTE Wireless spectrum required for a set of mobile subscribers or the size of a cell in a Mobile Network environment, to determine the processing power required in a CMTS Core or the Ethernet bandwidth capacity required in a Spine/Leaf network or the DOCSIS bandwidth capacity required in an HFC plant connected to a RPHY Node for High-Speed Data delivery to DOCSIS subscribers connected to a single HFC plant. Thus, Traffic Engineering can be applied across a broad array of applications within a large number of infrastructure types (Voice, Video, and Data) used by a large number of Service Providers (Telcos, Cable MSOs, and Wireless Providers).

For all of these applications, it is beneficial to be able to accurately realistically simulate the traffic that network would, or does, experience in actual use. To this end, many traffic simulation systems and software have been developed, but existing traffic simulation does not fully capture the range of traffic conditions a network experiences in the real world.

What is desired, therefore, are improved systems and methods for simulating real world traffic in a communications network.

### BRIEF DESCRIPTION OF THE DRAWINGS

For a better understanding of the invention, and to show how the same may be carried into effect, reference will now be made, by way of example, to the accompanying drawings, in which:

FIG. 1 shows an R-PHY system where a CMTS core at a head end exchanges data with a plurality of cable modems through a network of ethernet switches and Remote PHY devices.

FIG. 2 shows a block diagram of the system of FIG. 1 also having a database that collects system traffic data used by a traffic simulator to test of the system.

FIG. 3 shows an exemplary method by which the system of FIG. 2 may collect the traffic data.

FIGS. 4A and 4B respectively show an exemplary probability distribution function (pdf) and an exemplary cumulative distribution function (cdf) created in the method of FIG. 3.

FIG. 5 shows an exemplary traffic simulation system that uses the cumulative distribution functions created in the method of FIG. 3 to test the system of FIG. 2 with simulated traffic.

FIG. 6 shows an example of traffic simulated by the system of FIG. 5.

FIG. 7 shows an exemplary method used by the system of FIG. 5 to simulate traffic.

### DETAILED DESCRIPTION

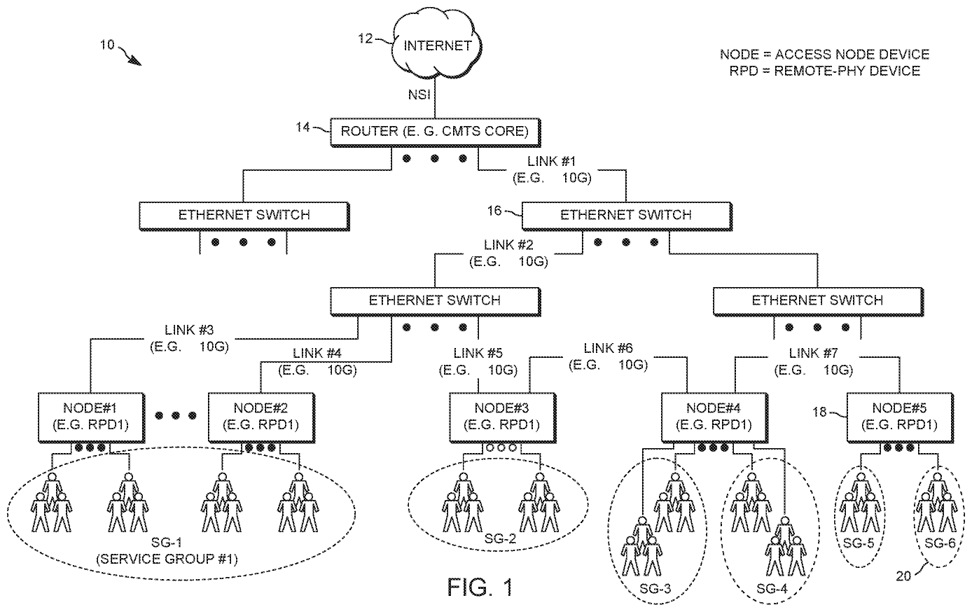

Referring to FIG. 1, a distributed access architecture 10 may be used to distribute content to a plurality of customer or subscriber groups 20 from the Internet 12 via a router 14 and a network of Ethernet switches 16 and nodes 18. In this architecture, the router 14 may receive downstream content from the Internet 12 and relay that content along a branched network, controlled by the Ethernet switches 16 to nodes 18. Each node 18 services a respective group of subscribers 20. The distributed access architecture is a remote-PHY (or R-PHY) system where the functionality ordinarily born by a Converged Cable Access Platform (CCAP) in a CMTS is split between a core in the CMTS 14 and the plurality of nodes 18 downstream from the CMTS, each of which act as the physical layer devices in the architecture. Thus, while the core in the CMTS 14 performs the higher layer processing, the R-PHY devices in the nodes 18 convert the downstream data sent by the core from digital-to-analog to be transmitted on radio frequency, and converts the upstream RF data sent by cable modems from analog-to-digital format to be transmitted optically to the core devices, as is well known in the art.

Those of ordinary skill in the art will also appreciate that, although an R-PHY distributed access architecture of a CATV system is used to illustrate the benefits of the present disclosure, this system is used for illustrative purposes only, as the disclosed system and methods may be applied across a wide variety of architectures that extend well beyond a CATV application. For example, the disclosed systems and methods may be used in other data distribution systems, e.g. cellular networks, telephone/DSL networks, passive optical networks (PON), etc. Thus, the disclosed systems and methods are relevant to any system that delivers data, voice, video, and other such downstream content from a common source to a multiplicity of customers via a distribution network, and or delivers upstream content from each of a multiplicity of customers to a common destination via such a distribution network.

As noted earlier, from a traffic engineering standpoint, it is often useful to test systems like the one shown in FIG. 1 under real-world traffic conditions for troubleshooting purposes, or alternately for example, to test such systems under realistic conditions hypothesized to exist in the future should current growth trends in service groups continue. To that end, traffic generation systems and software are useful to impose simulated traffic on a system. But existing traffic generation hardware and software such as Ixia, Spirent Smartbits etc., cannot adequately simulate traffic often encountered in the actual operation of the system as, in order to provide very high levels of traffic, such hardware essentially repeats a limited number of traffic patterns. Moreover, such existing hardware also can be tremendously expensive because of scaling and ‘randomizing’ limitations when large numbers of ‘end users’ need to be simulated. The traffic generated from this specialized hardware, i.e. Poisson traffic, constant bit rate traffic, or a single or multiple streams of deterministic varying bandwidth cannot fully test the capabilities of systems such as an I-CMTS, CCAP core or RMD as compared to real-world situations, which also can vary greatly from one MSO to another.

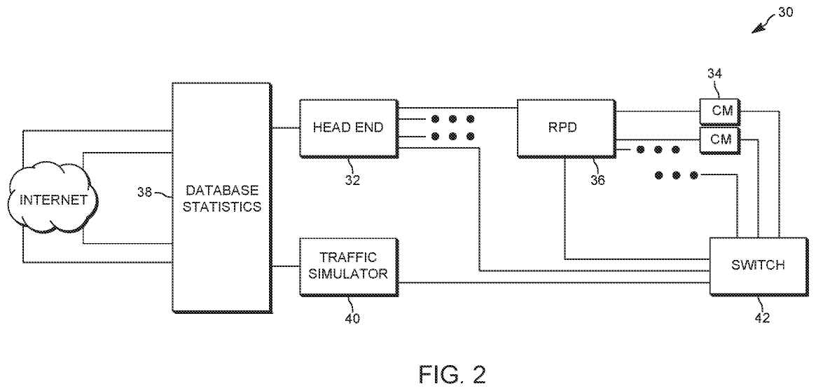

FIG. 2 broadly illustrates an improved traffic generation system applied to a transmission architecture, such as that shown in FIG. 1. The illustration describes that a traffic simulator can be placed as a network element anywhere within a network and can be utilized for measurement of statistics such as latency, utilization, packet drops, etc. Specifically, a transmission architecture 30 may include a head end 32 (which may be the CCAP core of FIG. 1, for example) communicating with a plurality of cable modems 34 via a branched network of nodes 36 (which may be the RPDs of FIG. 1, for example. FIG. 2 also shows a database 38 that collects real-world traffic data from the transmission system. Any number of different techniques may be employed to gather the traffic data. For example, the database 38 may include “white box” hardware that can receive one or more Ethernet links to the head end 32 at a relatively high data-rate, where preferably the number of ingress Ethernet links into the white box hardware should be greater than or equal to the number of active ingress Ethernet links feeding the head end 32. The Ethernet links connected to these input ports on the white box hardware should also be connected to ports on a router or a switch (not shown) upstream of the head end 32. The downstream packets feeding the head end can then be port-mirrored and sent to both the head end 32 and the white box hardware. This enables the creation of the head end's downstream traffic database statistics. Upstream packets received at the head end 32 and forwarded to the north side interface of the head end can also be port-mirrored and sent to both the Internet and the white box hardware to create the traffic database in the upstream of the head end.

Since the white box hardware receives every packet sent to and sent from the head end 32, it can record bandwidth to and from each subscriber IP address on a second-by-second basis or on an X-unit time interval by an X-unit time interval basis (whereby the time interval X could be set to various values, such as X=100 milliseconds or X=10 seconds). This information can be constantly updated and archived to a disk within the database, or to a remote disk farm. This permits the white box hardware to continually update and expand on the accumulated bandwidths for all subscribers.

Alternatively, a system such as that shown in FIG. 1 may include octet counters at one or more of the Ethernet switches 16 or nodes 18, so as to count the number of packets passing through to particular subscribers or groups of subscribers. This method may be useful, for example, to track statistical data on traffic generated by an aggregate groups of subscribers to test the system under a series of growth scenarios where traffic to and from different subscriber groups grow at different rates. The octet counter may be incremented by the number of octets in a packet every time a packet for the particular subscriber or group of subscribers passes. That octet counter can then be sampled once per second. The sampled octet count values from each successive 1-second sample time can then be stored in a memory. After some number of samples have been collected, the sampled octet counters can be stored in persistent memory, and the process can then be repeated. After these octet count values have been stored in persistent memory, post-processing of the persisted samples can be performed. The post processing would merely subtract successive values from one another to determine the delta octet value (in units of octets) for each 1-second sampling period. That delta octet value can then be multiplied by 8 to create the delta bit value (in units of bits) for each 1-second sampling period. That delta bit value can then be divided by the sampling period (which in this case is 1 second) to create the average bandwidth (in units of bits per second) for each 1-second sampling period. This creates a vector of average bandwidth values (in units of bits per second and sampled at 1-second intervals) for the aggregate group of subscribers. Those of ordinary skill in the art will appreciate that many different techniques may be possible to collect statistical data on the actual traffic flowing through the system 30.

Alternatively, a system can be created that does not need to sample at the high sampling rates implied by sampling all of the data every second. In this alternative instantiation, the system can randomly sample the data for a single subscriber or for a group of subscribers for a one-second window of time. A subsequent sample for that single subscriber or for that group of subscribers can then be collected at another random time in the future. This approach would require more elapsed time to collect an adequately-sized set of samples, but the approach helps to reduce the speed of sampling and therefore helps to reduce the complexity of the data collection hardware.

In some embodiments, the data in the database can be input by a user directly, or in a semi-automated method, processes ‘.pcap’ files taken in the field to provide the data stored in the database and to be processed as later described.

The statistical data stored in the database 38 may in turn be used by a traffic simulator 40 to randomly produce realistic traffic patterns that the system 30 may experience, as explained later in the specification. The traffic simulator 40, in turn, may be used to drive the system 30 with simulated traffic via a switch 42 connected to each of the cable modems 34 as well as the head end 32 and/or the RPD so as to be capable of testing all components of the system using upstream or downstream simulated traffic. Thus, even though FIG. 2 shows one connection from the switch 42 to the head end 32, for example, those of ordinary skill in the art will understand that where necessary, any number of connections may be employed to be able to independently direct upstream and/or downstream simulated traffic through the head end, or the RPD, etc.

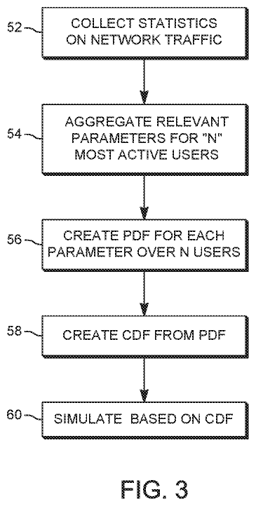

Referring to FIG. 3, information in the database 38 is preferably processed so that it is expressed in a form easily usable by the traffic simulator 40, which will be described in more detail later in this specification. Specifically, a processor either in the database or having access to it may preferably implement a method 50 that at step 52 collects statistics on network traffic as described earlier, and at step 54 aggregates relevant parameters for the “n” most active users in the networks. Preferably, the number “n” is selected to aggregate statistics for as many users as is feasible to simulate using the hardware of the traffic simulator 40. Those of ordinary skill in the art will recognize that many different relevant parameters are possible, but in a preferred embodiment, aggregated parameters include: (i) a height (H) of data-transmission per unit time by a user, service group, etc., e.g. the number of packets, bits, etc. transmitted per unit time, such as a second; (ii) a length (L) of data-transmission representing the time that a user, service groups etc. is transmitting data, during which the height (H) may vary from one unit time to another; and (iii) an inter data-transmission interval (I) which represents the duration of time between successive data transmissions of length L by a user, service group, etc.

At step 56, a probability distribution function (PDF) is created for each of the aggregated parameters over all of the “n” subscribers, e.g. a PDF for “H”, a PDF for “L”, and a PDF for “I” etc. A probability density function is a function whose value at any given sample (or point) in the sample space (the set of possible values taken by the random variable) can be interpreted as providing a relative likelihood that the value of the random variable would equal that sample. More precisely, a PDF is used to specify the probability of a random variable falling within a particular range of values, as opposed to taking on any one value. This probability is given by the integral of this variable's PDF over that range—that is, it is given by the area under the density function but above the horizontal axis and between the lowest and greatest values of the range. The probability density function is nonnegative everywhere, and its integral over the entire space is equal to one.

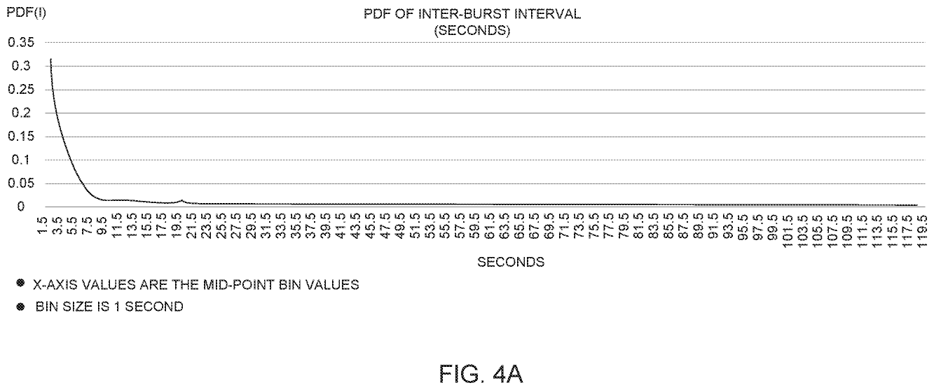

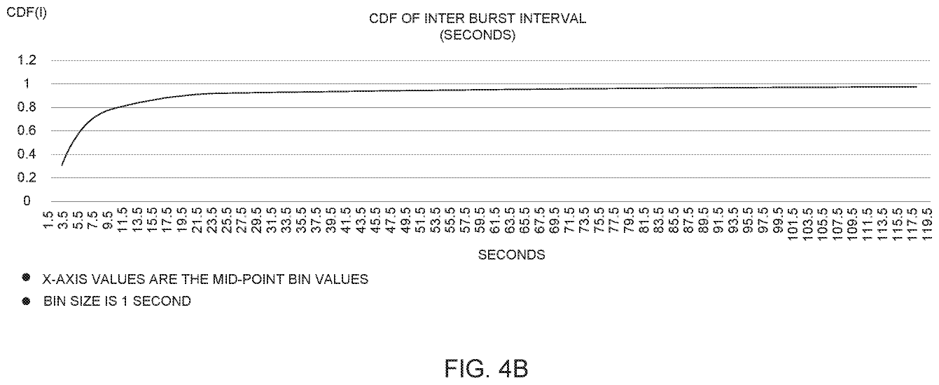

Any appropriate method may be used to generate the probability functions described herein, such as those use in U.S. patent application Ser. No. 15/992,164, filed on May 29, 2018, the disclosure or which is incorporated herein in its entirety. FIG. 4A shows an exemplary probability density function for the parameter (I) as described in this disclosure.

At step 58, the PDF created in the preceding step is used to create a cumulative distribution function (CDF) of the relevant parameter, which is a function that shows the probability (vertical axis) that the relevant parameter (e.g. H, L, I) will take on a value less than or equal to a number specified on the horizontal axis. FIG. 4B shows an exemplary CDF created from the PDF of FIG. 4A. Those of ordinary skill in the art will recognize that the manner in which a PDF may be mathematically converted to a CDF is well understood. At step 60, the CDFs created in step 58 may be used to realistically simulate traffic in a network.

Those of ordinary skill in the art will appreciate that the processing of the statistical data as just described may be performed in the database 38, or by an external unit with access to the database, including the traffic simulator 40.

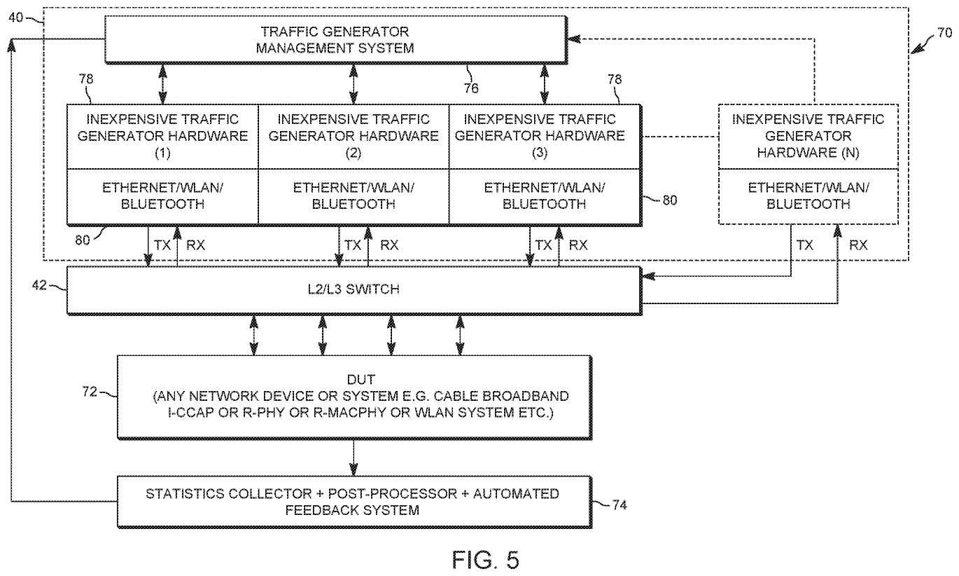

FIG. 5 shows a system 70 comprising an exemplary traffic simulator 40 connected to a switch 42 used to simulate traffic in a device under test 72, which may for example be any of the cable modems 34 or the head end 32, or the RPDs 36 of FIG. 2. The traffic simulator preferably includes a Traffic Generator Management System (TGMS) 76 used to use the cumulative distribution functions previously described to individually and independently drive each of a plurality of traffic generator hardware units 78 connected to switch 42 via respective interfaces 80, e.g. Ethernet, WLAN, Bluetooth, etc. In a preferred embodiment, each of the units 78 is preferably inexpensive; for example, each unit 78 may in some embodiments be a Raspberry Pi or other single-board computer. The units 78 are preferably driven to individually mimic the behavior of an individual customer, or a group of customers by releasing data to the switch 42 according to control of the TGMS.

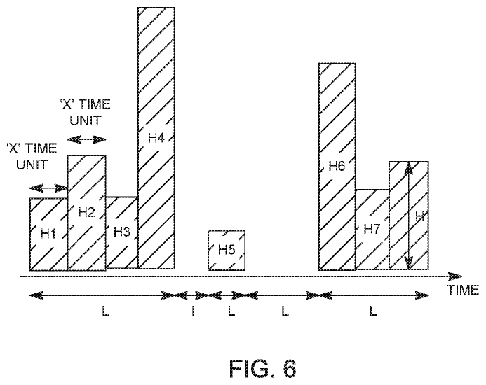

The TGMS 76, for example, may include a flexible control program—which can use random number generators and each of the CDFs to independently drive the units as if they were an individual modem, or a particular service group etc. Specifically, a random number generator may choose values between 0 and 1 for each of the y-axis parameters represented by CDFs, e.g. “H”, “L” and “I” and use those values to return the associated x-axis bin value of the respective CDF. In other words, for each unit 78, the TGMS 70 will use the CDFs to randomly select a length of transmission L, a value of H for each unit time in that length of transmission, and an inter-transmission interval after L expires. These values then will be used to cause the units 78 to independently release data to the switch 42 in conformance with those random values. FIG. 6 shows an example of traffic generated by a unit 78 driven using the CDFs as described in this disclosure. Since the selection is based on CDF of actual behavior of system traffic, the independent action of the units 79 will realistically simulate actual traffic patterns. Thus, the multiple instances of units 78 can be used to transmit data to a device under test 72 as described above, which stresses the device under test by creating non-deterministic data transmissions per unique stream per unit 78. The number of these instances is indeterminately large, allowing for a wide scale range to meet the needs of many configurations. Those of ordinary skill in the art will appreciate that in addition to parameters H, L, and I, other parameters may be desirable such as packet per time unit ramp-up interval, and packet per time interval ramp-down interval.

The system 70 may preferably include a Statistics Collector/Post-Processor 74 which includes instrumentation that monitors the output of the units 78 and the output of the switch 42 to determine effects such as latency, lost packets, etc., which will in turn depend on the load placed upon the system by the traffic simulator 40. Some embodiments may also mark packets from the units 78 to determine effects on the system from traffic loads generated by individual units 78. Those of ordinary skill in the art will appreciate that, although the Statistics Collector 74 is shown in FIG. 5 as an individual element, its functionality may be included in the TGMS 76.

Various layers of testing can be done using the system shown in FIG. 5, under speed and duration control, ICMP sending and receiving to monitor e.g. RTT under load conditions, speed-test for measuring Quality of Experience with a statically relevant background load, etc. Background load using standard applications could also be provided (either easily at will, for some or all the ‘CPE’ units, while others emit controlled packet streams to be closely measured and characterized. The utility of the system is enhanced in such cases by inherently accounting for the effects, for example, of TCP congestion control phenomenon, as well as by the type of congestion control and the way the device under test affects the handling of the traffic flow.

The system shown in FIG. 5 can be advantageously scaled by adding more units of inexpensive generic hardware to the traffic simulator 40, simulating large numbers of independent traffic providers. As a necessary adjunct facility, the combination of all the units 78, which could be of the order of a few hundred, is a management system for controlling, monitoring and updating the individual units.

Software for the traffic simulator 40 can also include unique and highly useful GUI's and statistics to ease the operation of the system and interpretation of results. This system would reside on a standard server external to the system and which is connected to the system via very conventional means (Ethernet/SSH for example).

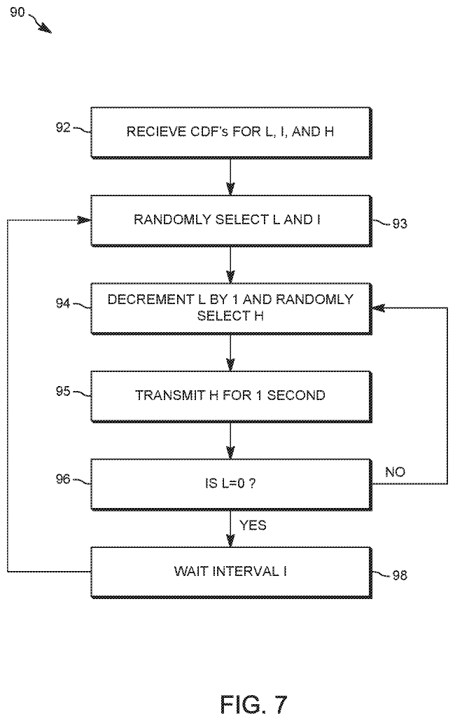

FIG. 7 shows an exemplary method 90 by which the functionality of each unit 78 in the traffic simulator 40, as described above, may be achieved using the parameters L, I, and H. At step 92, the traffic generator may receive CDFs for “L”, “I”, and “H”. At step 93, values for “L” and “I” are randomly selected using a random number generator and applying the results to the respective CDFs for those two parameters. At step 94, a value for “H” is selected in the same manner that “L” and “I” were selected and the value of “L” is decremented by 1. At step 95, data is transmitted from the respectively driven unit 78 at the selected value of “H” for one time interval, e.g. a second. At step 96, it is determined whether “L” is 0. If not, the procedure reverts to step 94. If “L” is zero, the procedure proceeds to step 98 where the unit 78 generates no traffic for a period “I”, after which the procedure reverts to step 93 so that a new burst of data may be generated. Those of ordinary skill in the art will understand the other procedures or sequences may be substituted for those shown. As just one example, decrementing L as shown in step 94 may be performed following the step 95 of transmitting H.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A traffic simulator selectively, operably connectable to at least one device under test in a data transmission system, the simulator comprising:
a plurality of hardware units, each capable of outputting data to the device under test independently of other ones of said plurality of hardware units; and
a manager configured to use statistical information of historical traffic through the data transmission system to independently drive each of the plurality of hardware units.

2. The traffic simulator of claim 1 where each of the plurality of hardware units are single-board computers.

3. The traffic simulator of claim 1 where the manager randomly drives each of the plurality of hardware units.

4. The traffic simulator of claim 1 where the manager used a cumulative distribution function to drive each of the plurality of hardware units, the cumulative distribution function based on the statistical information of historical traffic through the data transmission system.

5. The traffic simulator of claim 1 connected to a switch in the data transmission system, the switch connected to the device under test.

6. The traffic simulator of claim 1 including a post-processor that monitors the output of the hardware units.

7. The traffic simulator of claim 6 where the post processor monitors performance of the data transmission system as a function of the monitored output of the hardware units.

8. The traffic simulator of claim 6 where the output of at least one hardware unit is marked.

9. A method comprising:
storing historical statistical data of traffic through a communication network to a plurality of devices; and
using the stored historical statistical data to independently simulate traffic generated by each of the plurality of devices.

10. The method of claim 9 including using the stored historical data to create at least one probability density function, each associated with a respectively different statistical parameter of the traffic through the communication network.

11. The method of claim 10 including using the probability density function to create a cumulative distribution function.

12. The method of claim 11 including using the cumulative distribution function and a random number generator to independently simulate traffic generated by each of the plurality of devices.

13. The method of claim 10 including using a plurality of probability density functions, each associated with a respective one of a duration of transmission of a one of the plurality of devices, a time between successive transmissions by one of the plurality of devices, and an amount of throughput per unit time within the duration of transmission.

14. The method of claim 14 where the plurality of probability distribution functions are used to simulate stochastic behavior of each of the plurality of devices.

15. A system comprising:
a central unit communicating with each of a plurality of network devices through a transmission network;
a database that stores historical statistical data of traffic through the transmission network; and
a traffic simulator connected to at least one of the central unit and one or more of the plurality of network devices, the traffic simulator using information from the database to generate simulated traffic on the network.

16. The system of claim 15 implemented in a CATV transmission network.

17. The system of claim 15 where the traffic simulator comprises a plurality of simulation devices, each driven by the simulator to simulate the behavior of a respective one of the plurality of network devices.

18. The system of claim 17 where the traffic simulator uses a cumulative distribution function to independently drive each of the plurality of simulation devices, the cumulative distribution function based on the historical statistical data.

19. The system of claim 15 where the traffic simulator simulates upstream traffic.

20. The system of claim 15 where the traffic simulator simulates downstream traffic.
